(19) United States
(12) Patent Application Publication
(10) Pub. No.: US 2010/0186686 A1
(43) Pub. Date: Jul. 29, 2010

(54) HEATING SYSTEMS TO PREVENT FREEZING OF CONDENSATION IN BREATHER TUBES

(75) Inventors: Luis Carlos Cattani, Aurora, IL (US); Andrew Stobnicki, Deerfield, IL (US); Martin R. Zielke, Lockport, IL (US); Paul Gottemoller, Palos Heights, IL (US); Steven J. Dickerson, Lake in the Hills, IL (US); Doug Medynskyi, Elmwood Park, IL (US); Scott A. Beatty, La Grange, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(73) Assignee: International Engine Intellectual Property Company, LLC, Warrenville, IL (US)

(21) Appl. No.: 12/541,467

(22) Filed: Aug. 14, 2009

Related U.S. Application Data
(60) Provisional application No. 61/147,629, filed on Jan. 27, 2009.

(51) Int. Cl. F01P 5/10; F02B 25/06; F01M 5/00

(52) U.S. Cl. 123/41.44; 123/573; 184/6.22

(57) ABSTRACT

A heating system for an engine breather system includes a housing configured to contain a heating fluid to be in heat transfer communication with a portion of the engine breather system, such as with the outlet conduit. A heating fluid supply channel is connected to a supply of heating fluid that is at a first pressure and to the housing and arranged to direct heating fluid into the housing. A heating fluid return channel is connected to the housing and to a supply of heating fluid that is at a second pressure that is lower than the first pressure, and is arranged to direct heating fluid away from the housing. The heating fluid can be engine oil, engine coolant, compressed air or exhaust gas.

### REFERENCE TO RELATED APPLICATION AND PRIORITY CLAIM

This application claims the priority of Provisional Patent Application No. 61/147,629, filed on 27 Jan. 2009, the entire content of which is incorporated herein by reference.

### TECHNICAL FIELD OF THE INVENTION

This invention pertains to internal combustion engines, particularly to the treatment of blow-by gases.

### BACKGROUND OF THE INVENTION

Combustion gases are generated during the operation of an internal combustion engine. A small amount of these gases can leak past the piston seals of the internal combustion engine. These gases, commonly referred to in the art as blow-by gases, need to be released from the crankcase and are typically re-circulated into the engine air intake system or exhausted from the engine. Blow-by gases that are released from the crankcase carry combustion by-products and oil mist caused by splashing of the engine's moving components within the crankcase and the oil pan. It is known to substantially remove the oil mist from the blow-by gas prior to introduction into the intake air system. An apparatus that removes oil mist from blow-by gases is commonly referred to as a breather.

In a closed breather system, blow by gases passing through the breather can be re-circulated into the air intake of the engine, either into the intake manifold of a normally aspirated engine or into the inlet of a turbine-driven compressor of a turbocharger arrangement. Alternately, in an open breather system, the blow-by gases passing through the breather are directed into the exhaust system.

The blow-by gas can contains water vapor. Under some circumstances, this water may condense within the breather mechanism. Cold temperatures may cause freezing of this condensation within the breather mechanism. The outlet tube of the breather system is probably a location of increases susceptibility to freezing of water vapor.

In an open breather system, if a large amount of ice could form near the output of the breather mechanism, the flow of gas through the mechanism may be impeded. In a closed breather system, ice may reenter the engine air intake system. The presence of ice in various engine components could hinder the engine performance.

Insulation has been used on outlet tubes of breather systems. Heat-producing electric resistance systems have also been used.

The present inventor has recognized that a need exists for a mechanism that effectively and consistently prevents the freezing of water within breather systems.

The present inventor has recognized that a need exists for a mechanism to prevent the freezing of water within breather systems that does not substantially raise the cost of the system and its production.

The present inventor has recognized that a need exists for a mechanism to prevent the freezing of water within breather systems that does not substantially increase the complexity and size of the system.

### SUMMARY OF THE INVENTION

Exemplary embodiments of the present invention provide a heating system for use with a breather system on an engine. The breather system comprises an input for receiving engine gases, an arrangement for separating engine gases and engine oil and directing engine oil back into the crankcase, and an outlet conduit for directing engine gases either back into the engine air intake or to the exhaust. A breather system and breather is described for example in U.S. Pat. No. 7,185,643, herein incorporated by reference. The heating system according to the herein described embodiments includes a fluid-driven heat transfer mechanism in heat transfer communication with the breather.

According to an exemplary embodiment, the heating system for the engine breather system includes a housing configured to contain a heating fluid to be in heat transfer communication with a portion of the engine breather system, such as with the outlet conduit. A heating fluid supply channel is connected to a supply of heating fluid that is at a first pressure and to the housing and arranged to direct heating fluid into the housing. A heating fluid return channel is connected to the housing and to a supply of heating fluid that is at a second pressure that is lower than the first pressure, and is arranged to direct heating fluid away from the housing.

According to an exemplary embodiment, the heating system housing surrounds the portion of the breather system and the heating fluid is in heat transfer contact with the portion of the breather system.

According to one embodiment, the supply of heating fluid includes a supply of engine oil, and an engine oil pump circulating engine oil throughout the engine by pressurizing engine oil from an engine sump. The pump has a discharge side for circulating the pressurized oil. The heating fluid supply channel is connected to the discharge side of the pump and the heating fluid return channel is connected to the sump.

According to another embodiment, the supply of heating fluid includes a supply of engine coolant, and a coolant pump circulating coolant throughout the engine by pressurizing coolant from a lower pressure side to a higher pressure. The heating fluid supply channel is connected to the higher pressure side of the pump and the heating fluid return channel is connected to the lower pressure side of the pump.

According to a further embodiment, the supply of heating fluid includes a supply of engine exhaust gas in an exhaust gas system having a higher pressure side and a lower pressure side. The heating fluid supply channel is connected to the higher pressure side of the exhaust gas system and the heating fluid return channel is connected to the lower pressure side of the exhaust gas system.

According to a still further embodiment, the supply of heating fluid includes an air compressor generating a supply of compressed air at a higher pressure from a supply of air at a lower pressure. The heating fluid supply channel is connected to the supply of compressed air and the heating fluid return channel is connected to the supply of air at a lower pressure, such as to ambient air.

According to another aspect of the aforementioned embodiments, the housing can be in heat transfer communication with the portion of the engine breather system, such as the output conduit, by conduction through a solid member, such as a plate, and the heating fluid can be isolated from the portion of the breather system.

Numerous other advantages and features of the present invention will e become readily apparent from the following detailed description of the invention and the embodiments thereof, and from the accompanying drawings.

### BRIEF DESCRIPTION OF THE DRAWINGS

FIG. 1 is a schematic drawing of an engine and closed breather system;

FIG. 2 is a schematic drawing of an engine and closed breather system with a turbocharger included;

FIG. 3 is a schematic drawing of an engine with an open breather system;

FIG. 4 is a schematic drawing of the heating system of the present invention; and

FIG. 5 is a schematic drawing of an alternate embodiment heating system of the present invention.

### DETAILED DESCRIPTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

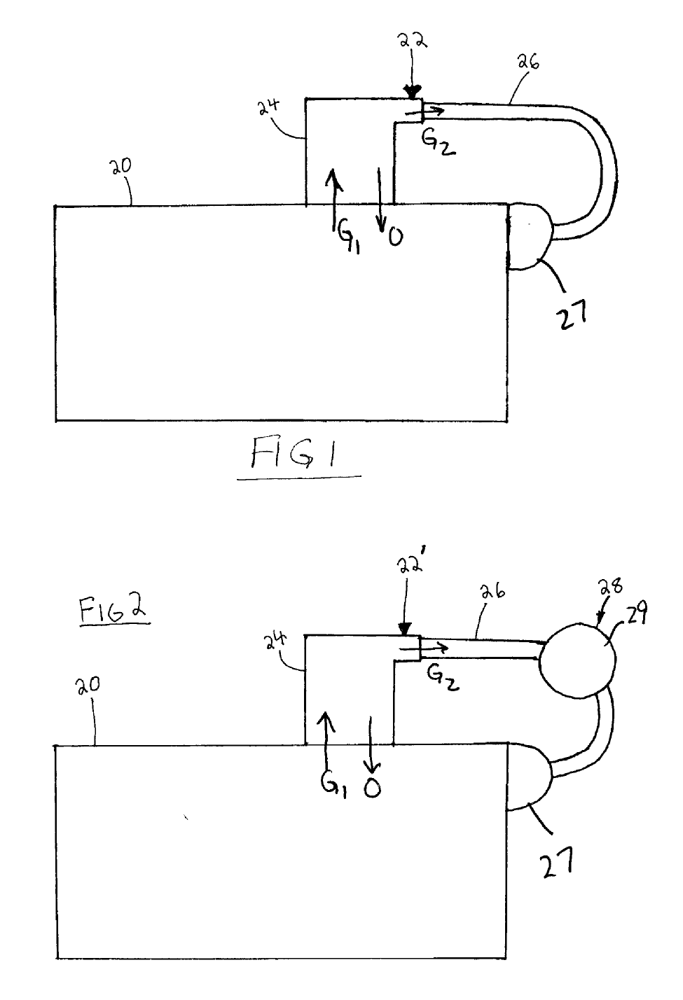

FIG. 1 is a schematic diagram that shows a vehicle engine 20 with a closed breather system 22. Closed breather system 22 includes a breather 24 and an outlet tube 26 as described in U.S. Pat. No. 7,185,643. Blow-by gases G₁ from engine 20 are pressured through or drawn through the engine 20 into the breather system 22. The gases are channeled by the breather 24 as described in U.S. Pat. No. 7,185,643, oil O is removed from the gases G₁, and gases G₂ exit the breather 24 through outlet tube 26. Oil O separated from the gases G₁ by the breather 24 flows downward into the crankcase of the engine 20. In this particular embodiment, the outlet tube 26 directs the gases G₂ into an intake manifold 27 of the engine 20, where they will reenter the combustion process.

FIG. 2 shows a similar arrangement but with an added turbocharger 28. Gases from the engine 20 enter the breather system 22 and exit the breather 24 through the outlet tube 26. Outlet tube 26 directs the gases G₂ to an inlet of an air compressor 29 of the turbocharger 28, and the gases G₂ along with intake air, is compressed and enters the intake manifold 27 of the engine 20 and into the combustion process.

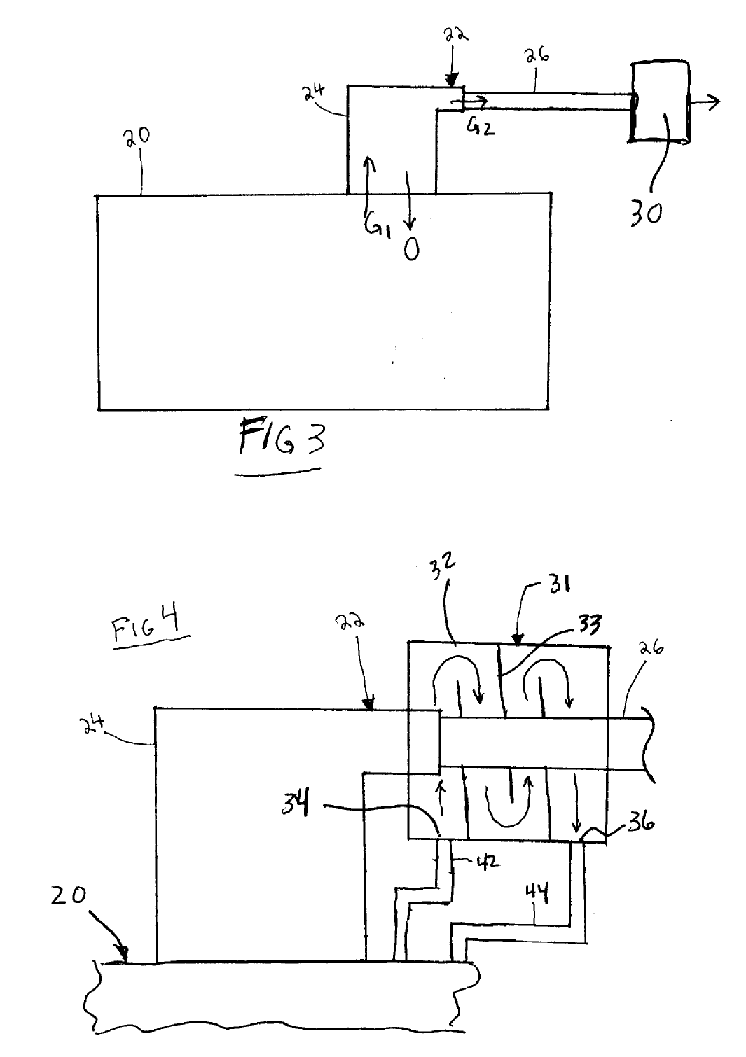

FIG. 3 shows the engine 20 with a breather system 22′. In this embodiment, breather system 22′ is an open breather system. Outlet tube 26 directs gases from the breather 24 into the engine exhaust system 30.

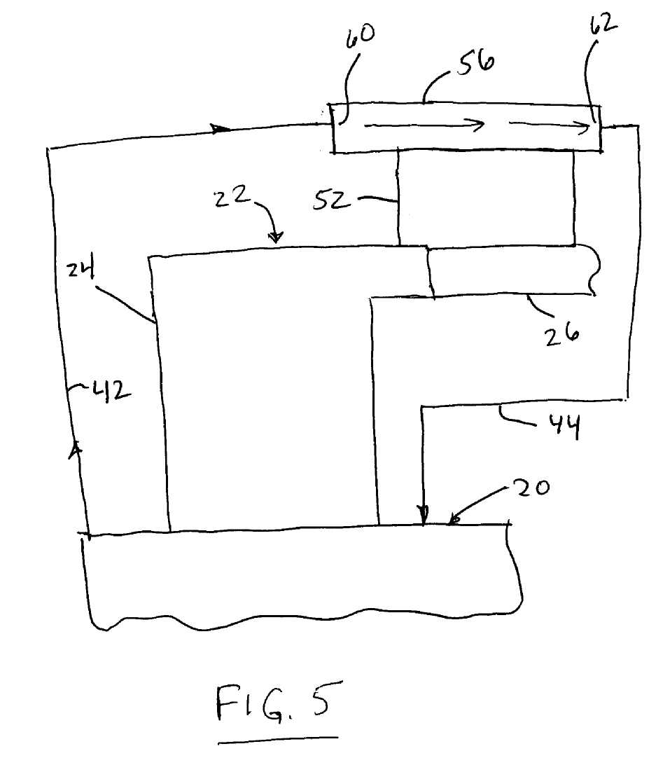

FIG. 4 shows the heating system 31 of the present invention. In the aforementioned embodiments, heating system 31 is located and arranged to transfer heat into the breather system 22. Heating system can be arranged around outlet tube 26. The gases in outlet tube 26 are kept warm by heating system 31. Heating system 31 can be applied to a portion or the entirety of outlet tube 26.

In one embodiment, heating system 31 includes a housing or jacket 32 having baffles 33 as needed to cause heating fluid to flow around the tube 26 from an inlet 34 to an outlet 36. A heating fluid supply channel or tube 42 connects a supply of heating fluid from the engine to the inlet 34 and a heating fluid return channel or tube 44 connects the outlet 36 to a heating fluid return to the engine 20.

The heating system 31 utilizes heating fluids that are typically already present in an engine. If the engine oil or coolant system is used, heating fluid supply tube 42 and heating fluid return tube 44 may be tubes circulating the oil or coolant from engine 20 to heating system 31.

If engine oil is used as the heating fluid, the oil pump that circulates engine oil throughout the engine can be used as the fluid driver to circulate engine oil through the jacket 32. Engine oil would be delivered from some point on the discharge side of the pump (elevated pressure) to the tube 42 and the tube 44 would be deliver engine oil from the jacket 32 to a suction side of the oil pump, such as back to the oil pan (low pressure).

If engine coolant is used as the heating fluid, the coolant pump that circulates coolant throughout an engine and the engine radiator can be used as the fluid driver to circulate engine coolant through the jacket 32. Coolant would be delivered from some point on the discharge side of the coolant pump (elevated pressure) to the tube 42 and the tube 44 would be deliver coolant from the jacket 32 to a suction side of the coolant pump (lower pressure).

If exhaust gas is used as the heating fluid, the heating fluid supply channel 42 may be a tube connected between the exhaust gas manifold and the inlet 34 and the heating fluid return channel 44 may be a tube connected between the outlet 36 and the engine exhaust gas pipe further downstream in the exhaust gas system. The differential pressure between the elevated pressure of the exhaust gas from the exhaust manifold and atmospheric pressure (or the reduced pressure downstream of a turbocharger turbine) can be used to drive the exhaust gas through the jacket 32.

If compressed air is used as the heating fluid, heating fluid supply channel 42 may be a tube connected between the compressed air intake manifold and the inlet 34 and the heating fluid return channel 44 may be connected between the outlet 36 and atmosphere or the compressor air intake. The differential pressure between the elevated pressure of the compressed intake manifold air or an inter-stage air pressure and atmospheric pressure (or the intake air pressure at the compressor air intake) can be used to drive the compressed air through the jacket 32.

FIG. 5 illustrates an alternate embodiment wherein a conduction member, such as a plate 52 is solidly connected between the tube 26 and a housing 56. The housing 56 includes a housing inlet 60 and a housing outlet 62. The plate 52 and the housing 56 are composed of heat conducting material such as a metal, such as steel or aluminum. The inlet 60 receives heating fluid from the heating fluid supply tube 42 and the outlet 62 delivers the heating fluid to the heating fluid return tube 44. The housing can be configured in similar fashion as the housing 32 shown in FIG. 4 or can be a pipe conducting flow in an axial direction along the axis of the pipe. The heating fluid can be any of those described above. Heat is transferred from the flowing heating fluid, though the housing 56, between the housing 56 and the plate 52 by conduction and between the plate 52 and the tube 26 by conduction.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A heating system for an engine breather system, the engine breather system having an input for receiving engine gases, an arrangement for separating engine gases and engine oil, and an outlet conduit for directing engine gases, comprising:
a housing configured to contain a heating fluid to be in heat transfer communication with a portion of the engine breather system;
a heating fluid supply channel connected to a supply of heating fluid that is at a first pressure and to the housing and arranged to direct heating fluid into the housing; and
a heating fluid return channel connected to a supply of heating fluid that is at a second pressure that is lower than the first pressure and to the housing and arranged to direct heating fluid away from the housing.

2. The heating system according to claim 1, wherein the housing surrounds the portion of the breather system and the heating fluid is in heat transfer contact with the portion of the breather system.

3. The heating system according to claim 2, wherein the supply of heating fluid comprises:
a supply of engine oil;
an engine oil pump circulating engine oil throughout the engine by pressurizing engine oil from an engine sump, the pump having a discharge side for delivering the pressurized oil; and
the heating fluid supply channel is connected to the discharge side of the pump and the heating fluid return channel is connected to the sump.

4. The heating system according to claim 2, wherein the supply of heating fluid comprises:
a supply of engine coolant;
a coolant pump circulating coolant throughout the engine by pressurizing coolant from a lower pressure side to a higher pressure; and
the heating fluid supply channel is connected to the higher pressure side of the pump and the heating fluid return channel is connected to the lower pressure side of the pump.

5. The heating system according to claim 2, wherein the supply of heating fluid comprises:
a supply of engine exhaust gas in an exhaust gas system having a higher pressure side and a lower pressure side; and
the heating fluid supply channel is connected to the higher pressure side of the exhaust gas system and the heating fluid return channel is connected to the lower pressure side of the exhaust gas system.

6. The heating system according to claim 2, wherein the supply of heating fluid comprises:
an air compressor generating a supply of compressed air at a higher pressure from a supply of air at a lower pressure; and
the heating fluid supply channel is connected to the supply of compressed air and the heating fluid return channel is connected to the supply of air at a lower pressure.

7. The heating system according to claim 6, wherein the supply of air at a lower pressure is ambient air at atmospheric pressure.

8. The heating system according to claim 1, wherein the housing is in heat transfer communication with the portion by conduction through a solid member and the heating fluid is isolated from the portion of the breather system.

9. The heating system according to claim 8, wherein the supply of heating fluid comprises:
a supply of engine fluid;
an engine fluid pump circulating engine fluid throughout the engine by pressurizing engine fluid from a lower pressure side to a higher pressure side; and
the heating fluid supply channel is connected to the higher pressure side of the pump and the heating fluid return channel is connected to the lower pressure side of the pump.

10. The heating system according to claim 8, wherein the supply of heating fluid comprises:
a supply of engine exhaust gas in an exhaust gas system having a higher pressure side and a lower pressure side; and
the heating fluid supply channel is connected to the higher pressure side of the exhaust gas system and the heating fluid return channel is connected to the lower pressure side of the exhaust gas system.

11. The heating system according to claim 8, wherein the supply of heating fluid comprises:
an air compressor generating a supply of compressed air at a higher pressure from a supply of air at a lower pressure; and
the heating fluid supply channel is connected to the supply of compressed air and the heating fluid return channel is connected to the supply of air at a lower pressure.

12. A heating system for an engine breather system, the engine breather system having an input for receiving engine gases, an arrangement for separating engine gases and engine oil, and an outlet conduit for directing engine gases, comprising:
a means for heating the engine breather system;
a heating fluid circulating means for directing heating fluid to the means for heating, through the means for heating, and away from the means for heating.

13. The heating system according to claim 12, wherein the means for heating comprises a housing that contains heating fluid and surrounds a portion of the outlet conduit of the breather system.

14. The heating system according to claim 12, wherein the heating fluid circulating means comprises:
a supply of engine fluid;
an engine fluid pump circulating engine fluid throughout the engine by pressurizing engine fluid from a lower pressure side to a higher pressure side; and
a heating fluid supply channel connected to the higher pressure side and a heating fluid return channel connected to the lower pressure side, the heating fluid supply channel and the heating fluid return channel connected to the means for heating.

15. The heating system according to claim 12, wherein the heating fluid circulating means comprises:
a supply of engine exhaust gas in an exhaust gas system having a higher pressure side and a lower pressure side; and
a heating fluid supply channel connected to the higher pressure side of the exhaust gas system and a heating fluid return channel connected to the lower pressure side of the exhaust gas system.

16. The heating system according to claim 12, wherein the supply of heating fluid comprises:
an air compressor generating a supply of compressed air at a higher pressure from a supply of air at a lower pressure; and
the heating fluid supply channel is connected to the supply of compressed air and the heating fluid return channel is connected to the supply of air at a lower pressure.

17. A method of heating an engine breather system, the engine breather system having an input for receiving engine gases, an arrangement for separating engine gases and engine oil, and an outlet conduit for directing engine gases, comprising the steps of:
directing a side stream of engine fluid from an engine fluid system to the engine breather system;
transferring heat from the side stream to the engine breather system.

18. The method according to claim 17, comprising the further step of:
After the step of transferring heat, returning the side stream from the engine breather system back to the engine fluid system.

19. The method according to claim 17, wherein the engine fluid is a fluid selected from the group consisting of engine oil and engine coolant.

20. The method according to claim 17, wherein the engine fluid is a fluid selected from the group consisting of compressed air and engine exhaust.
